(19) United States
(12) Patent Application Publication
(10) Pub. No.: US 2009/0108076 A1
(43) Pub. Date: Apr. 30, 2009

(54) Electro-optical reader switchable between handheld and hands-free modes of operation by non-magnetic, immobile switch

(76) Inventors: Edward Barkan, Miller Place, NY (US); Igor Vinogradov, New York, NY (US)

Correspondence Address: KIRSCHSTEIN, ISRAEL, SCHIFFMILLER & PIERONI, P.C., 425 Fifth Avenue, 5TH FLOOR, New York, NY, 10016-2223, US

(21) Appl. No.: 11/981,446

(22) Filed: Oct. 31, 2007

(51) Int. Cl. G06K 7/10

(52) U.S. Cl. 235/462.48; 235/462.32; 235/462.41; 235/473; 369/52.1

(57) ABSTRACT

An immobile, non-magnetic mode sensor, preferably an optical sensor, is entirely supported by a housing of a reader for electro-optically reading indicia in a handheld mode, and in a hands-free mode, of operation. The mode sensor is operative for sensing the mode of operation, for example, by detecting whether the housing has been grasped by an operator, or by detecting whether the housing has been removed from a support surface. The mode sensor is actuatable between handheld and hands-free states, which respectively correspond to the handheld and hands-free modes of operation. A controller is operative for selecting the mode of operation, which is sensed by the mode sensor, in which the indicia is to be read.

### DESCRIPTION OF THE RELATED ART

Moving laser beam-based readers, in both handheld and hands-free modes of operation, have been used to electro-optically read coded symbols, particularly one-dimensional Universal Product Code (UPC) type symbols, in supermarkets, warehouse clubs, department stores, and other kinds of retailers for many years. A laser generates a laser beam directed to a symbol, that is located in a range of working distances from the reader and that is associated with a product, for reflection and scattering from the symbol. A detector having a field of view detects light of variable intensity returning from the symbol. A scanner scans at least one of the laser beam and the field of view in a scan pattern comprised of one or more scan lines. When at least one of the scan lines sweeps over the symbol, an electrical signal indicative of the intensity of the detected return light is processed by signal processing circuitry including a microprocessor; the symbol is read; and the product is identified.

Imager-based readers, in both handheld and hands-free modes of operation, have also been used to electro-optically read targets such as coded symbols, particularly two-dimensional symbols, in a range of working distances from the reader by employing a solid-state imager to capture an image of each symbol. The imager comprises an array of cells or photosensors, which correspond to image elements or pixels in a field of view of the imager. Such an array may be comprised of a one- or two-dimensional charge coupled device (CCD) or a complementary metal oxide semiconductor (CMOS) device, analogous to those devices used in a digital camera to capture images.

The imager-based reader further typically includes an illuminator to illuminate the symbol during its reading with illumination light emitted from an illumination light source and directed to the symbol for reflection and/or scattering therefrom. The illumination light source may be located within and/or externally of the reader, and comprises one or more light emitting diodes (LEDs). The imager-based reader yet further typically includes an aiming light source for projecting an aiming spot on the symbol to facilitate aiming prior to reading, as well as electronic circuitry for producing electrical signals indicative of the light captured by the array, and a microprocessor for processing the electrical signals to produce each captured image.

It is therefore known to use a solid-state imager for capturing a monochrome image of a symbol as, for example, disclosed in U.S. Pat. No. 5,703,349. It is also known to use a solid-state imager with multiple buried channels for capturing a full color image of a target as, for example, disclosed in U.S. Pat. No. 4,613,895. It is common to provide a two-dimensional CCD with a 640×480 resolution commonly found in VGA monitors, although other resolution sizes are possible.

In the hands-free mode of either the moving laser beam-based reader or the imager-based reader, an operator may slide or swipe the product bearing the symbol past a window of either reader in a stroke, either from right to left, or from left to right, or at any angle of inclination, in a “swipe” mode. Alternatively, the operator may present the symbol on the product, preferably to an approximate central region of the respective window, and hold the product at least momentarily steady in a “presentation” mode. The operator may present the symbol anywhere within the field of view, including at the edges of the window. The choice depends on operator preference or on the layout of a workstation in which the reader is used. The operator does not touch, grasp or hold the respective reader in the hands-free mode.

In the handheld mode of either the moving laser beam-based reader or the imager-based reader, the operator grasps and holds the respective reader in his or her hand during reading and aims the reader at the symbol to be read. The operator may first lift the reader from a countertop or a support cradle. Reading is initiated typically by having the operator manually actuate a trigger with his or her finger. Trigger actuation helps to avoid accidentally reading the wrong symbol. Once reading is completed, the operator may return the reader to the countertop or to the support cradle.

Although the known moving laser beam-based reader and the known imager-based reader are generally satisfactory for their intended purposes, each reader often needs to change its reading functionality when it is in the handheld mode, as opposed to when it is in the hands-free mode. For example, a reader may only require a short working distance in the hands-free mode, and a long working distance in the handheld mode. Hybrid readers have been described as containing both a moving laser beam-based module and an imager-based module. One of the modules may be better for reading certain symbols in a particular mode, as opposed to the other module in the other mode.

These differences in operational behavior between the hands-free and handheld modes require the reader to sense when it is in at least one of the modes, and to automatically change to the other of the modes when the reader senses that the reader is in the other mode. For example, the reader needs to be capable of switching from the hands-free mode to the handheld mode when the reader is picked up by the operator from a countertop, or like support surface.

To accomplish such switching, it is known, for example, to use a mechanical plunger on a base of the reader. The plunger is physically pushed inwardly into the base when the reader is resting on the support surface in the hands-free mode. The plunger is spring-loaded, and automatically moves outwardly of the base when the reader is lifted from the support surface. The plunger physically moves an opaque component into or out of a path of a light beam emitted by a light source to a light detector. This movement interrupts the light beam and enables the reader to determine when it has been lifted off the support surface, thereby signaling the reader to change operating modes. A mechanical switch having a movable armature could serve the same function. Yet, the known plunger/switch mechanisms are perceived to be unreliable by operators who are concerned that contamination by dirt, dust, moisture and like contaminants, as well as physical wear, can eventually cause the mechanisms to jam or fail.

Another way that known readers have detected when they are picked up is by installing a magnet in the stand or support cradle that is provided to support the reader in the hands-free mode. A magnetic sensor, such as a reed switch or a Hall effect sensor, is mounted in the reader in close proximity to the cradle magnet when the reader is placed in the stand or cradle, thereby allowing the reader to sense when it is placed in, or removed from, the stand or cradle by magnetic field interaction and interruption. Yet, it is not always possible to install the magnetic mechanisms in the reader or the cradle, and the known magnetic mechanisms require a dedicated stand or cradle. Some readers do not utilize a dedicated stand or cradle. Some workstations do not have room available for such a dedicated stand or cradle, and some operators do not routinely use, or want, such a dedicated stand or cradle.

### SUMMARY OF THE INVENTION

One feature of the present invention resides, briefly stated, in a reader for, and a method of, electro-optically reading indicia, especially one- and/or two-dimensional symbols. Each symbol includes elements of different light reflectivity, e.g., bars and spaces. The reader could be configured, in one embodiment, as a hands-free and/or a hand-held housing having a window. The housing may have a handle for handheld mode operation and/or a base for supporting the housing on a support surface for hands-free mode operation. Preferably, the base is connected to the housing in both the handheld and hands-free modes by being pivotably connected to the handle. Also, the housing is preferably configured with a gun-shaped configuration, and a manually actuatable trigger is provided on the housing at a location underlying an operator's forefinger when the operator holds the handle in the operator's hand.

In some applications, the window could be omitted, in which event, the reader has a windowless opening at which the indicia are located for reading. As used herein, the term “presentation area” is intended to cover both a window and a windowless opening. In the case of the hands-free reader, the symbol is swiped past, or presented to, the presentation area and, in the case of the handheld reader, the reader itself is moved and the presentation area is aimed at the symbol. In the preferred embodiments, the reader is installed in a retail establishment, such as a drug store, a book store, an office supply store, and a liquor store, especially in a cramped environment.

In a preferred embodiment, an imaging module having electro-optical components is supported by the housing, and includes a one- or two-dimensional, solid-state imager mounted in the reader. The imager has an array of image sensors operative, together with an imaging lens assembly, for capturing light, in either the handheld mode or the hands-free mode, from a one- or two-dimensional symbol or target through the presentation area during the reading to produce a captured image with the aid of a controller or programmed microprocessor. Preferably, the array is a CCD or a CMOS array. The imaging module includes an illuminator for illuminating the symbol during the reading with illumination light directed from an illumination light source through the presentation area. The illumination light source comprises one or more light emitting diodes (LEDs). The illuminator is especially useful when the reader is operated in low light or dark ambient environments, but could equally well be used at normal indoor lighting levels. An aiming light assembly can be used to locate the symbol prior to reading.

In another preferred embodiment, a laser scanning module having electro-optical components is supported by the housing and includes a scanner for scanning, in either the handheld mode or the hands-free mode, at least one of a laser beam from a laser and a field of view of a light detector in a scan pattern, typically comprised of one or more scan lines, across the indicia during reading. The laser scanning module may also include signal processing circuitry for processing an electrical analog signal generated by the light detector, and a digitizer for converting the analog signal to a digital signal for subsequent decoding by a controller or programmed microprocessor. In yet another preferred embodiment, both the above-described laser scanning module and the above-described imaging module are supported by the same housing, and the modules may share the same controller, as well as the same presentation area or window.

In accordance with one aspect of this invention, an immobile, non-magnetic mode sensor is entirely supported by the housing and is operative for sensing the mode of operation. The mode sensor is actuatable between handheld and hands-free states that respectively correspond to the handheld and hands-free modes of operation. The term “immobile” signifies that the mode sensor has no moving parts. This counters the perception in the prior art by some operators who are concerned that contamination by dirt, dust, moisture and like contaminants, as well as physical wear, can eventually cause a mode sensor having moving parts to jam or fail. The term “non-magnetic” signifies that the mode sensor has no magnets or magnetic field sensors. This eliminates the prior art requirement to provide dedicated stands or cradles with magnets. A controller or programmed microprocessor is operatively connected to the mode sensor, for selecting the mode of operation, which is sensed by the mode sensor, in which the indicia is to be read.

Preferably, the mode sensor is operative for sensing the handheld mode of operation by detecting whether the housing has been grasped by an operator's hand, or by detecting whether the housing has been removed from a support surface. The mode sensor is advantageously an optical switch that includes an optical emitter for emitting a control beam, and an optical detector for detecting the control beam in one of the modes. The optical emitter is operative for emitting the control beam toward the operator's hand or the support surface.

In one embodiment, the housing has a base generally lying in a plane, and the optical emitter is operative for emitting the control beam along a path at an acute angle of incidence relative to the plane. A baffle between the optical emitter and the optical detector is operative for blocking light, other than the control beam, from reaching the optical detector. In another embodiment, the optical emitter includes a first lightpipe for guiding the control beam along the path to the operator's hand or the support surface for reflection and/or scattering therefrom as return light, and the optical detector includes a second lightpipe for guiding the return light to the optical detector. The optical emitter and the optical detector are advantageously mounted on a generally planar board in close proximity to the base, and the optical emitter and the optical detector face away from the generally planar board toward their respective lightpipes.

The reader typically has a trigger for initiating the reading during the hand-held mode. In an exemplary embodiment, the controller activates the trigger in the hand-held state of the mode sensor, and deactivates the trigger in the hands-free state of the mode sensor. The imaging module has different functionalities, and the controller activates one of the functionalities of the imaging module in the hand-held state of the mode sensor, and activates another of the functionalities of the imaging module in the hands-free state of the mode sensor. The laser scanning module also has different functionalities, and, analogously, the controller activates one of the functionalities of the laser scanning module in the hand-held state of the mode sensor, and activates another of the functionalities of the laser scanning module in the hands-free state of the mode sensor. The various functionalities of each module may include, but is not intended to be limited to, selecting short or long ranges of working distance, enabling or disabling the trigger, enabling or disabling the aiming light source, selecting one from a plurality of different aiming light patterns, narrowing or widening the field of view, discriminating between one- and two-dimensional symbols, changing the resolution of the imager, etc.

In a hybrid reader, both the laser scanning module and the imaging module are in the same housing and share the same controller and the same window. The controller activates one of the modules in the hand-held state of the mode sensor, and activates another of the modules in the hands-free state of the mode sensor. In some applications, one module may be better suited to read a particular symbol than the other module.

Another aspect of the invention still further resides in a method of electro-optically reading indicia in a handheld mode, and in a hands-free mode, of operation, comprising the steps of: supporting electro-optical components for reading the indicia by a housing; sensing the mode of operation by actuating an immobile, non-magnetic mode sensor, entirely supported by the housing, between handheld and hands-free states which respectively correspond to the handheld and hands-free modes of operation; and selecting the mode of operation, that is sensed by the mode sensor, in which the indicia is to be read. The sensing step is performed by sensing the handheld mode of operation by detecting whether the housing has been grasped by an operator, or by detecting whether the housing has been removed from a support surface.

The novel features which are considered as characteristic of the invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a perspective view of an electro-optical reader operative in either a hand-held mode, or a hands-free mode, for reading indicia in accordance with this invention;

FIG. 2 is a broken-away, sectional view of the reader of FIG. 1 schematically depicting various components therein in accordance with one embodiment of this invention;

FIG. 3 is a broken-away, sectional view of a portion of the reader of FIG. 1 depicting various components therein in a hands-free mode of operation in accordance with another embodiment of this invention;

FIG. 4 is a view analogous to FIG. 3, but in a handheld mode of operation in accordance with this invention;

FIG. 5 is a broken-away, sectional view of a portion of the reader of FIG. 1 depicting various components therein in a hands-free mode of operation in accordance with yet another embodiment of this invention;

FIG. 6 is a view analogous to FIG. 5, but in a handheld mode of operation in accordance with this invention; and

FIG. 7 is a view of another embodiment in a hands-free mode of operation in accordance with this invention.

### DETAILED DESCRIPTION OF THE PREFERRED EMBODIMENTS

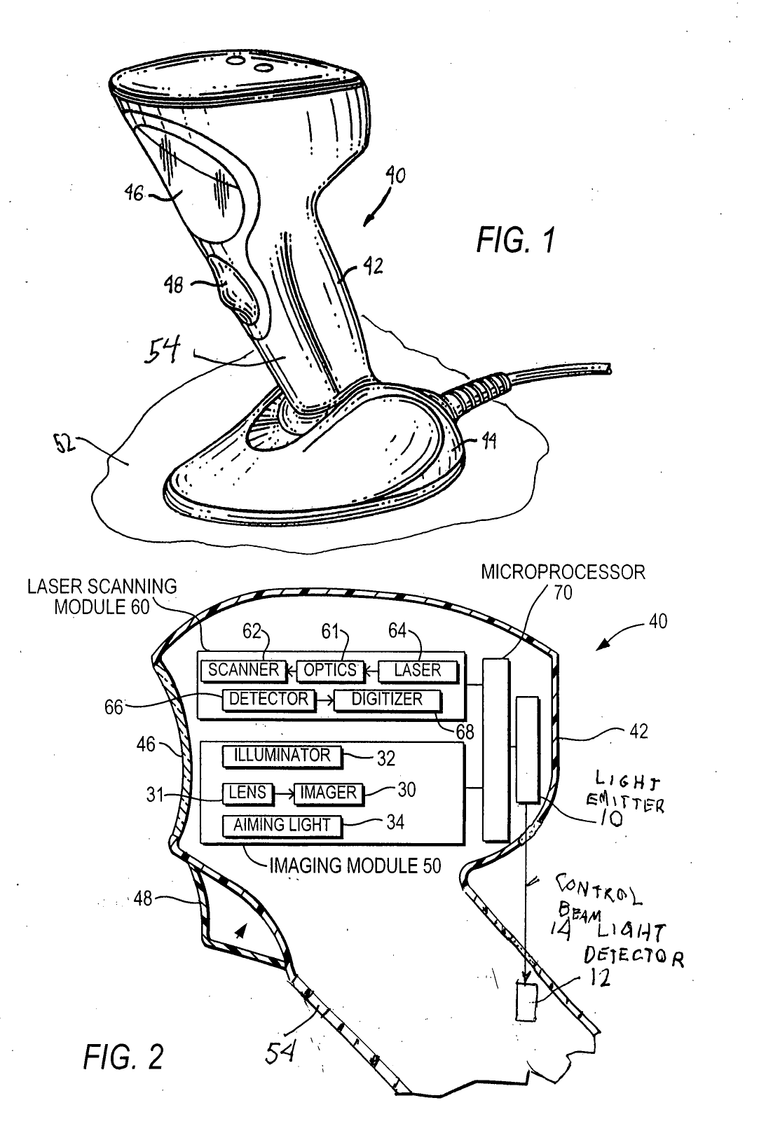

Reference numeral 40 in FIG. 1 generally identifies an electro-optical, portable reader having a gun-shaped housing 42 connected to a base 44. The base 44 rests on a countertop or analogous support surface 52 and serves for supporting the reader 40. The reader 40 can thus be used in a hands-free mode as a stationary workstation in which products bearing indicia, such as one- or two-dimensional symbols, are presented to, or slid or swiped past, a presentation area or window 46. The gun-shaped housing 42 also has a handle 54 that can be picked up by an operator off the countertop and held in the operator's hand in a handheld mode. A trigger 48 is located on the gun-shaped housing 42 at a location underlying an operator's forefinger when the operator holds the handle 54 in the operator's hand in the handheld mode. The trigger 48 is manually depressed to initiate reading of the symbol. The handle 54 is permanently and pivotably connected to the base 44 in both the handheld and hands-free modes for pivoting movement about a generally horizontal pivot axis, that is generally parallel to, and elevated above, the countertop. The housing 42 is adjustably tiltable forward and back about the pivot axis in the hands-free mode to aim the window 46 at the symbol to be read.

The reader 40 may have an imaging module 50 supported by the housing 42, in which event the imaging module 50 includes a one- or two-dimensional, solid-state imager 30 mounted in the reader. The imager 30 has an array of image sensors operative, together with an imaging lens assembly 31, for capturing light from a one- or two-dimensional symbol or target through the presentation area 46 during the reading to produce an electrical signal indicative of a captured image for subsequent decoding. Preferably, the array is a CCD or a CMOS array having a 752×480 resolution (wide VGA), although other resolution sizes are possible. The imaging module 50 includes an illuminator 32 for illuminating the symbol during the reading with illumination light directed from an illumination light source through the presentation area 46. The illumination light source comprises one or more light emitting diodes (LEDs). The illuminator 32 is especially useful when the reader 40 is operated in low light or dark ambient environments, but could equally well be used at normal indoor lighting levels. An aiming light generator 34 may also be provided for projecting an aiming light pattern or mark on the symbol prior to reading.

In operation of the imaging module 50, a controller 70 sends a command signal to pulse the illuminator LEDs 32 for a short time period, say 500 microseconds or less, and energizes the imager 40 during an exposure time period of a frame to collect light from a target symbol during said time period. A typical array needs about 33 milliseconds to read the entire target image and operates at a frame rate of about 30 frames per second. The array may have on the order of one million addressable image sensors.

The reader 40 may alternatively have a laser scanning module 60 supported by the housing 42, in which event the laser scanning module 60 includes a scanner 62 for scanning at least one of a laser beam from a laser 64 and a field of view of a light detector 66 in a scan pattern, typically comprised of one or more scan lines, across the indicia during reading. The laser scanning module 60 may also include optics 61 for focusing the laser beam to have a large depth of field, and a digitizer 68 for converting an electrical analog signal generated by the detector 66 into a digital signal for subsequent decoding,

In operation of the laser scanning module 60, the controller 70 energizes the laser to emit the laser beam, and energizes the scanner to sweep the laser beam in the scan pattern. The controller 70 also processes the digitized signal from the digitizer 68 into data descriptive of the symbol.

As illustrated in FIG. 2, the reader 40 may comprise both the laser scanning module 60 and the imaging module 50 in the same housing 42 and share the same controller 70 and the same presentation area 46 or window.

In accordance with one aspect of this invention, an immobile, non-magnetic mode sensor is entirely supported by the housing 42 and is operative for sensing the mode of operation of the reader 40. The controller 70 or programmed microprocessor is operatively connected to the mode sensor, for selecting the mode of operation, which is sensed by the mode sensor, in which the indicia is to be read. As shown in the embodiment of FIG. 2, the mode sensor is advantageously an optical switch that includes an optical light emitter 10 for emitting a control beam 14, and an optical light detector 12 for detecting the control beam 14 in one of the modes. As explained below, the mode sensor 10, 12 is actuatable between handheld and hands-free states that respectively correspond to the handheld and hands-free modes of operation. The term “immobile” signifies that the mode sensor 10, 12 has no moving parts. The term “non-magnetic” signifies that the mode sensor 10, 12 has no magnets or magnetic field sensors.

In FIG. 2, the mode sensor 10, 12 is operative for sensing the handheld mode of operation by detecting whether the housing 42 has been grasped by an operator's hand. By default, the control beam 14 is detected by the detector 12 in the hands-free mode. When the operator grasps the reader, his or her hand will unavoidably interrupt the control beam 14, thereby generating a control signal to instruct the controller 70 to automatically switch the reader to the handheld mode. This beam interruption is especially useful when the operator is wearing a glove. In a variation, the default mode could be the handheld mode. Also, the emitter 10 and the detector 12 need not be collinearly located and spaced apart along the path of the control beam 14, but instead, could be arranged adjacent one another, in which case, the switching action need not be as a result of interrupting the control beam, but instead, could be the result of the operator's hand reflecting and/or scattering the control beam to the detector 12.

In another variation, the emitter 10 and the detector 12 need not be respectively located in an upper and a lower part of the housing 42. Their positions could be reversed. Also, they need not be located at a rear end of the housing, but preferably could be located at a front end of the housing. It is particularly advantageous if the control beam 14 passes in front of the trigger 48. The emitter and the detector can be located anywhere on the housing. Preferably, the control beam passes through light-transmissive areas of the housing. Advantageously, the emitter 10 emits infrared light that is not readily visible to the operator.

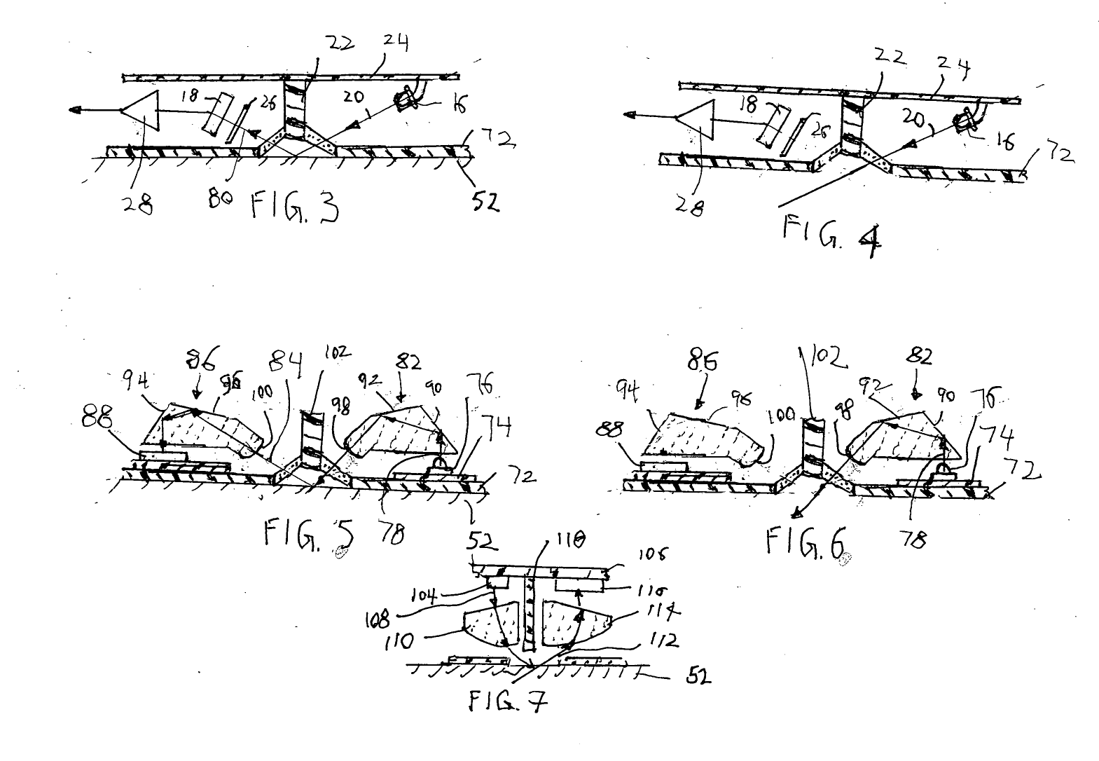

In FIGS. 3-6, the mode sensor is operative for sensing the handheld mode of operation by detecting whether the housing 42 has been removed from the support surface 52. In the embodiment of FIGS. 3-4, the base 44 of the housing 42 has a bottom face 72 generally lying in a plane, and an optical emitter 16, preferably an infrared light emitting diode (LED) mounted on a printed circuit board (PCB) 24 spaced from the bottom face 72, is operative for emitting a control beam 20 along a path at an acute angle of incidence relative to the plane. A baffle 22 between the optical emitter 16 and an optical detector 18 is operative for preventing crosstalk between the emitter and the detector by blocking light, other than the control beam 20, from reaching the optical detector 18.

In the hands-free mode of FIG. 3, the bottom face 72 rests on the support surface 52, and the control beam 20 reflects and/or scatters from the support surface 52 as return light 80. If the support surface is glossy, then the return light is a specular reflection, and the angle of reflection equals the angle of incidence. If the support surface is not glossy, then the return light 80 scatters in all directions, and a portion of the scattered light passes through an optical filter 26 to the detector 18, which generates a control signal that is conducted to an amplifier 28.

By default, the control beam 20 is detected by the detector 18 in the hands-free mode. When the operator lifts the reader from the support surface, as depicted in FIG. 4, there is no reflected or scattered light that is returned to the detector 18. The absence of such return light instructs the controller 70 to automatically switch the reader to the handheld mode. In a variation, the default mode could be the handheld mode. Also, the positions of the emitter 16 and the detector 18 could be reversed. Another way of improving detection of the return signal is to modulate the emitter 16 with a unique known frequency, and filter out that frequency in the amplifier 28.

When there is insufficient room to accommodate the emitter 16 below the PCB 24 and between the PCB 24 and the bottom face 72 of the base 44, then, as shown in the embodiment of FIGS. 5-6, a PCB 74 is mounted on or closely adjacent the bottom face 72, and an optical emitter, preferably an LED 76, is surface-mounted on the PCB 74 and emits a control beam 78 vertically upwardly away from the bottom face 72 in a direction generally perpendicular to the PCB 74. A first lightpipe 82 is operative for guiding the control beam 78 along a folded path to the support surface 52 for reflection and/or scattering therefrom as return light 84 in the hands-free mode of FIG. 5. A second lightpipe 86 is operative for guiding the return light 84 along a folded path from the support surface 52 to an optical detector 88. The optical detector 88 is advantageously mounted on the same or a different PCB as the optical emitter, and also faces vertically upwardly away from the PCB 74 toward the lightpipe 86.

By default, the control beam 84 is detected by the detector 88 in the hands-free mode. When the operator lifts the reader from the support surface, as depicted in FIG. 6, there is no reflected or scattered light that is returned to the detector 88. The absence of such return light instructs the controller 70 to automatically switch the reader to the handheld mode. In a variation, the default mode could be the handheld mode. Also, the positions of the emitter 76 and the detector 88 could be reversed.

Each lightpipe 82, 86 could be coated with light-reflective coatings to guide the control beam 78 and the return light 84 along their respectively illustrated folded paths, but, in a cost-effective embodiment, the angles of reflective surfaces 90, 92, 94, 96 of the lightpipes 82, 86 are optimized to provide total internal reflection (TIR). The exit surfaces 98, 100 of the lightpipes 82, 86 are curved to provide an optical power to focus the control beam 78 and the return light 84 at the support surface 52. Each lightpipe can be molded from a colored plastic material to filter out the useful signal. Thus, if the emitter emits red-colored light, then it is advantageous if the lightpipe is molded from a red-colored plastic material.

A baffle 102 between the optical emitter 76 and the optical detector 88 is operative for preventing crosstalk therebetween. An optical filter, analogous to filter 26, can be used to pass the scattered light to the detector 18. The emitter 76 can be modulated with a unique known frequency, and that frequency can be filtered out in an amplifier, analogous to amplifier 28.

FIG. 7 depicts a currently preferred embodiment in which an optical emitter, preferably an LED 104, is surface-mounted on a PCB 106 and emits a control beam 108 downwardly in a direction generally perpendicular to the PCB 106. A first lightpipe 110, advantageously a prism, is operative for guiding the control beam 108 along a folded path to the support surface 52 for reflection and/or scattering therefrom as return light 112 in the hands-free mode. A second lightpipe 114, also advantageously a prism, is operative for guiding the return light 112 along a folded path from the support surface 52 vertically to an optical detector 116 surface-mounted on the PCB 106. A baffle 118 prevents crosstalk between the emitter 104 and the detector 116.

Rather than relying on the presence or absence of the support surface 52 in FIGS. 3-7, these embodiments can also work by relying on the presence or absence of the operator's hand. The operator's hand, just like the support surface, can reflect and/or scatter light. These embodiments may not be optimal for all skin colorations, or when the operator is wearing a glove. Also, some readers do not have a distinct handle as in a gun-shaped reader, but instead, have a trigger on one or both sides of a box-shaped housing. Each trigger can be depressed by the operator's fingers when the reader is lifted from the support surface 52. Small projections can be designed into the housing above and below each trigger. An emitter can be located in one projection, and a detector can be located in the other projection, so that a control beam can be projected above the respective trigger from one projection to the other, where the control beam will be blocked by the operator's fingers and thereby cause the reader to change functionality. If there are two triggers, one on each side of the reader, then there can be two control beams. Alternatively, the control beam does not have to sense a finger on a trigger, but instead, can be positioned to detect the operator's fingers anywhere they might be normally positioned to grip the reader in the hand-held mode.

This invention is intended to include any immobile, non-magnetic, mode sensor, preferably optically-based. It is also possible to devise capacitive switches or conductive sensors (by placing conductive surfaces on neighboring areas of the handle and by detecting small electrical currents or voltages when an operator's hand bridges the conductive surfaces) to achieve the same function.

The trigger 48 is operative for initiating the reading during the hand-held mode. In an exemplary embodiment, the controller 70 activates the trigger 48 in the hand-held state of the mode sensor, and deactivates the trigger 48 in the hands-free state of the mode sensor. The imaging module 50 has different functionalities, and the controller 70 activates one of the functionalities of the imaging module 50 in the hand-held state of the mode sensor, and activates another of the functionalities of the imaging module 50 in the hands-free state of the mode sensor. The laser scanning module 60 also has different functionalities, and, analogously, the controller 70 activates one of the functionalities of the laser scanning module 60 in the hand-held state of the mode sensor, and activates another of the functionalities of the laser scanning module 60 in the hands-free state of the mode sensor. The various functionalities of each module 50, 60 may include, but is not intended to be limited to, selecting short or long ranges of working distance, enabling or disabling the trigger 48, enabling or disabling the aiming light source 34, selecting one from a plurality of different aiming light patterns, narrowing or widening the field of view, discriminating between one- and two-dimensional symbols, changing the resolution of the imager 30, etc.

In a hybrid reader, both the laser scanning module 60 and the imaging module 50 are in the same housing 42 and share the same controller 70. The controller 70 activates one of the modules in the hand-held state of the mode sensor, and activates another of the modules in the hands-free state of the mode sensor. In some applications, one module may be better suited to read a particular symbol than the other module.

It will be understood that each of the elements described above, or two or more together, also may find a useful application in other types of constructions differing from the types described above. Thus, readers having different configurations can be used.

While the invention has been illustrated and described as integrating a non-magnetic, immobile switch for switching an electro-optical reader between handheld and hands-free modes of operation in accordance with a method for performing this switching action, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention and, therefore, such adaptations should and are intended to be comprehended within the meaning and range of equivalence of the following claims.

What is claimed as new and desired to be protected by Letters Patent is set forth in the appended claims.

We claim:

1. A reader for electro-optically reading indicia in a handheld mode, and in a hands-free mode, of operation, comprising:
a housing having electro-optical components for reading the indicia;
an immobile, non-magnetic mode sensor entirely supported by the housing for sensing the mode of operation, the mode sensor being actuatable between handheld and hands-free states which respectively correspond to the handheld and hands-free modes of operation; and
a controller operatively connected to the mode sensor, for selecting the mode of operation, that is sensed by the mode sensor, in which the indicia is to be read.

2. The reader of claim 1, wherein the mode sensor is operative for sensing the handheld mode of operation by detecting whether the housing has been grasped by an operator.

3. The reader of claim 1, wherein the mode sensor is operative for sensing the handheld mode of operation by detecting whether the housing has been removed from a support surface.

4. The reader of claim 1, wherein the mode sensor is an optical switch that includes an optical emitter for emitting a control beam, and an optical detector for detecting the control beam in one of the modes.

5. The reader of claim 4, wherein the optical emitter is operative for emitting the control beam toward one of an operator's hand and a support surface.

6. The reader of claim 4, wherein the housing has a base generally lying in a plane, and wherein the optical emitter is operative for emitting the control beam along a path at an acute angle of incidence relative to the plane; and a baffle between the optical emitter and the optical detector, for blocking light, other than the control beam, from reaching the optical detector.

7. The reader of claim 6, wherein the optical emitter includes a first lightpipe for guiding the control beam along the path to one of an operator's hand and a support surface for reflection and scattering therefrom as return light, and wherein the optical detector includes a second lightpipe for guiding the return light to the optical detector

8. The reader of claim 7, wherein the optical emitter and the optical detector are mounted on a generally planar board in close proximity to the base, and wherein the optical emitter and the optical detector face away from the generally planar board toward their respective lightpipes.

9. The reader of claim 1, and further comprising a trigger for initiating the reading during the hand-held mode; and wherein the controller activates the trigger in the hand-held state of the mode sensor, and deactivates the trigger in the hands-free state of the mode sensor.

10. The reader of claim 1, wherein the electro-optical components comprise an imaging module including a solid-state imager having an array of image sensors for capturing return light from the indicia during reading with different functionalities, and wherein the controller activates one of the functionalities of the imaging module in the hand-held state of the mode sensor, and activates another of the functionalities of the imaging module in the hands-free state of the mode sensor.

11. The reader of claim 1, wherein the electro-optical components comprise a laser scanning module including a scanner for scanning at least one of a laser beam from a laser and a field of view of a light detector in a scan pattern across the indicia during reading with different functionalities, and wherein the controller activates one of the functionalities of the laser scanning module in the hand-held state of the mode sensor, and activates another of the functionalities of the laser scanning module in the hands-free state of the mode sensor.

12. The reader of claim 1, wherein the electro-optical components comprise both a laser scanning module including a scanner for scanning at least one of a laser beam from a laser and a field of view of a light detector in a scan pattern across the indicia during reading, and an imaging module including a solid-state imager having an array of image sensors for capturing return light from the indicia during reading, and wherein the controller activates one of the modules in the hand-held state of the mode sensor, and activates another of the modules in the hands-free state of the mode sensor.

13. The reader of claim 1, wherein the housing has a handle to be held by an operator in the handheld mode of operation, and a base for supporting the housing on a support surface during the hands-free mode of operation.

14. The reader of claim 4, wherein the controller modulates the emitter to emit a modulated control beam, and a filter for filtering the modulated control beam.

15. A reader for electro-optically reading indicia in a handheld mode, and in a hands-free mode, of operation, comprising:
means for supporting electro-optical components for reading the indicia;
immobile, non-magnetic mode sensor means entirely supported by the supporting means for sensing the mode of operation, the mode sensor means being actuatable between handheld and hands-free states which respectively correspond to the handheld and hands-free modes of operation; and
means operatively connected to the mode sensor means, for selecting the mode of operation, that is sensed by the mode sensor means, in which the indicia is to be read.

16. A method of electro-optically reading indicia in a handheld mode, and in a hands-free mode, of operation, comprising the steps of:
supporting electro-optical components for reading the indicia with a housing;
sensing the mode of operation by actuating an immobile, non-magnetic mode sensor, entirely supported by the housing, between handheld and hands-free states which respectively correspond to the handheld and hands-free modes of operation; and
selecting the mode of operation, that is sensed by the mode sensor, in which the indicia is to be read.

17. The method of claim 16, wherein the sensing step is performed by sensing the handheld mode of operation by detecting whether the housing has been grasped by an operator.

18. The method of claim 16, wherein the sensing step is performed by sensing the handheld mode of operation by detecting whether the housing has been removed from a support surface.

19. The method of claim 16, wherein the sensing step is performed by emitting a control light beam, and detecting the control light beam in one of the modes.

20. The method of claim 16, and initiating the reading during the hand-held mode with a trigger; and wherein the selecting step is performed by activating the trigger in the hand-held state, and by deactivating the trigger in the hands-free state.

21. The method of claim 16, and configuring the electro-optical components to comprise an imaging module including a solid-state imager having an array of image sensors for capturing return light from the indicia during reading with different functionalities, and wherein the selecting step is performed by activating one of the functionalities of the imaging module in the hand-held state, and by activating another of the functionalities of the imaging module in the hands-free state.

22. The method of claim 16, and configuring the electro-optical components to comprise a laser scanning module including a scanner for scanning at least one of a laser beam from a laser and a field of view of a light detector in a scan pattern across the indicia during reading with different functionalities, and wherein the selecting step is performed by activating one of the functionalities of the laser scanning module in the hand-held state, and by activating another of the functionalities of the laser scanning module in the hands-free state.

23. The method of claim 16, and configuring the electro-optical components to comprise both a laser scanning module including a scanner for scanning at least one of a laser beam from a laser and a field of view of a light detector in a scan pattern across the indicia during reading, and an imaging module including a solid-state imager having an array of image sensors for capturing return light from the indicia during reading, and wherein the selecting step is performed by activating one of the modules in the hand-held state, and by activating another of the modules in the hands-free state.

24. The method of claim 19, and modulating the control light beam, and filtering the modulated control light beam.
